(19) United States
(12) Patent Application Publication
(10) Pub. No.: US 2026/0254642 A1
(43) Pub. Date: Aug. 27, 2026

(54) METHOD TO ALLOW NON-FUNGIBLE TOKEN TO BE APPLIED ON NON-CONSTANT DOCUMENT LIKE JPEG WITH THE ABILITY TO HIDE THE ORIGINAL IMAGE

(71) Applicant: Guy LE HENAFF, Montreal (CA)

(72) Inventor: Guy LE HENAFF, Montreal (CA)

(21) Appl. No.: 19/545,898

(22) Filed: Feb. 20, 2026

Related U.S. Application Data
(60) Provisional application No. 63/761,723, filed on Feb. 21, 2025.

(51) Int. Cl. H04L 9/32; G06F 21/60; G06F 21/62; G06V 10/74; G06V 10/764; G06V 20/00; G06V 30/418; H04L 9/00

(52) U.S. Cl. CPC H04L 9/32; G06F 21/602; G06F 21/6254; G06V 10/761; G06V 10/764; G06V 20/95; G06V 30/418; H04L 9/008

(57) ABSTRACT

A blockchain-based system and method for registering and authenticating ownership rights in digital images or physical objects represented thereby, robust to bit-level variations from recompression, recapture, or format conversion while maintaining cryptographic security. The registration process generates an obfuscated digest (optical signature) from the original image, sufficient for verification at a cryptographic collision-resistance level equivalent to conventional hashing, without exposing the non-obfuscated Reference object on the public blockchain.

### BACKGROUND

### (a) Field

The subject matter disclosed herein generally relates to techniques for removing the constraint that a blockchain or non-fungible token (NFT) system can only bind to a bit-exact file hash, while preserving a level of cryptographic assurance comparable to that of conventional hash-based identity mechanisms. In certain embodiments, the invention enables a unique and persistent linkage between a blockchain record (for example, an NFT) and a physical object or off-chain digital asset, the linkage being verifiable via on-demand image capture and comparison of a derived digest, without requiring disclosure or distribution of the original image data during routine authentication operations.

### (b) Related Prior Art

Conventional blockchain and NFT-based systems typically treat an image as a canonical byte stream or pixel matrix and rely on cryptographic hashing (e.g., SHA-256) of this exact data to derive a unique identifier. Such approaches require formats with perfectly reversible compression (e.g., PNG) or simple text, because even a single-bit change or any lossy transformation produces a drastically different hash, leading to the conclusion that the candidate image is not identical to the registered original at the byte level. In contrast, human observers routinely regard images as authentic when they are perceptually identical, even under zoom or other inspection tools, despite underlying byte-level differences caused by recompression, re-encoding, or recapture.

Lossy formats such as JPEG, as well as video frame reconstruction from interframe differences, inherently introduce binary differences even where the rendered image is visually indistinguishable to a human viewer. Likewise, multiple captures of the same physical object have a negligible probability of producing bitwise-identical image files. As a result, neither physical originals nor recompressed or recaptured derivatives can be reliably enrolled and authenticated in a digital wallet using exact binary matching alone.

Traditional methods for generating unique identifiers, such as affixed serial numbers, engravings, RFID tags, or embedded metadata, are either external to the image content or vulnerable to removal and tampering.

In NFT systems using proof-of-stake (PoS) or similar consensus mechanisms, the dominant practice is to extract a canonical byte sequence from the document or image and hash it to obtain a purportedly unique token identifier, which severely limits applicability to irreversibly compressed formats (like JPEG) or slightest image transformation like geometrical or color transformation.

A related extension of the art: U.S. Pat. No. 10,361,866B1 discloses on of these methodes like a “proof of image authentication on a blockchain” approach applied to images, in which an image authentication server performs reverse image searches and other comparative analyses to locate an existing instance of the original image, and then associates that original stream bytes with a blockchain record. These disclosures primarily adopt a backward-looking strategy that attempts to rediscover the exact original image or its pre-existing hash through mechanisms such as reverse image search, metadata analysis, or image comparison, after which conventional pixel-level hashing is applied to check consistency. While JPEG images are mentioned, the candidate image are treated as query inputs to search services rather than as the primary, robust sources for deriving cryptographically meaningful, forward-constructed identifiers directly from the pixel structure of a candidate image itself; the cited art does not provide an explicit forward method using directly the probe candidate for generating or comparing images at a level compatible with cryptographic level of qualification for example as required by the NFT usage, usable with non-identical, yet perceptually equivalent, images.

Further Limitations and Confidentiality Concerns: Current blockchain services, by design, expose payloads or payload-derived hashes and the origin of it to the public so that distributed nodes can perform independent verification, creating tension with scenarios in which the original image must remain confidential. Although payload encryption can conceal the original image, it undermines straightforward authentication because verifiers cannot access the plain bytes for direct comparison, and sharing decryption keys broadly would compromise privacy and control.

Therefore, there remains a need in the market for a way to save on a public database like a blockchain an obfuscated dataset representing the original document while still allowing authentication method to run on binary level variation of the document while delivering the same level of collision and risk when examining similarity as typically in use in blockchain industry.

### SUMMARY

The apparatus of the present invention addresses this need by enabling registration and authentication of digital images while storing information on a public database like blockchain, using an obfuscated representation and a comparison methodology analogous to that employed by visual experts rather than exact binary matching, but preserving the accuracy required by blockchain uniqueness.

While it may seem that encryption of a payload could fulfill this need, while always possible, there is a better security tradeoff in reducing the amount of information available for fulfilling the authentication mission to a strict minimum, rather than relying on encryption that while safe would require at certain stage that many operators need access to the decryption key which may lead to an information leak.

The original document may remain confidential or be discarded post-registration, as authentication of candidate objects relies solely on the stored digest (chaotic signature) serving as a proxy of the original document.

According to an aspect of the disclosure, there is provided a computer-implemented method for authenticating a candidate document against a reference document using a digest of the reference document stored in a database, the method comprising:
receiving one or more original images of the reference document;
processing the one or more original images to generate one or more sets of obfuscated data and associating a unique identifier therewith;
storing the one or more sets of obfuscated data as a digest of the reference document in the database;
receiving, from a computing device, an authenticity request for the candidate document to be compared against the reference document, the request including at least one candidate image;
searching the database to retrieve the one or more sets of obfuscated data associated with the reference document;
performing an authentication process on the data of the candidate document using the retrieved one or more sets of obfuscated data for the reference document; and
determining the similarity of the candidate document based on results of the authentication process.

According to an embodiment, the obfuscated data are encrypted.

According to an embodiment, obfuscated data are composed of two categories of data, one of them being simple values of a nature and quantity compatible with usage of a homomorphic encryption to be used for comparison and theses data being encrypted in a part of a payload of a blockchain allowing the authenticity action to be done using these data without a need for decryption.

According to an embodiment, the database is a blockchain.

According to an embodiment, the Reference object or set of documents is stored in its original form at a non-public location accessible to a reputable authority, and wherein the reputable authority processes the original image to verify genuineness of the alleged reference obfuscated data stored in the database.

According to an embodiment, successful authentication of the candidate image triggers computation of an additional set of obfuscated data therefrom, to enrich and update the set of obfuscated data for the reference document in the database.

According to another aspect of the disclosure, there is provided a method for authenticating a candidate document against a previously registered reference document stored in a database, the method comprising:
receiving one or more original images of the reference document,
processing the one or more original images to generate one or more set obfuscated data, associating a unique identifier from said set of obfuscated data;
storing in a database the set of obfuscated data and the associated unique identifier,
requesting from a computing device, an authenticity request for a given candidate document, to compare to the Reference object, the request containing at least one candidate,
computing a set of obfuscated data for this candidate,
searching the database using candidate obfuscated data to create a list of reference documents with similar obfuscated data,
performing directly on the candidate document the authentication process from outcome of search of obfuscated data reference documents
determining the authenticity of the given candidate image based on a result of the search and the authentication.

According to another aspect of the disclosure, there is provided a method for allowing comparison of images with a reference stored in a block chain the method comprising:
receiving original images from a Reference object and receiving a unique identifier or a unique description aimed at retrieving the data of the reference image, and additional information to uniquely identify an owner and uniquely naming the document for this owner;
processing at least one of the original images generating at least one chaotic signature in one or more original images associated with said Reference object;
generating a unique document identifier from the additional information to uniquely identify the owner and information from the document;
storing in a blockchain the chaotic signature indexed as a record belonging to the owner for this unique document;
requesting from a remote computing device, an authenticity request for a given candidate image, to compare to the Reference object image;
extracting, by image comparison from a database of all signatures for every document, a set of best-matching signatures;
asserting the unique document identifier that are common to the majority of the best-matching signatures and using it as an alleged unique document identifier;
accessing blockchain record using the image unique identifier;
performing a search for a pre-detected chaotic signature associated with one of the original references, within the received image of the given product, determining authenticity of the given candidate image based on a result of the search,
reporting the result of the authentication process to the authenticity request.

According to an embodiment, the unique identifier is deduced from classification of the candidate image chaotic signatures using organized chaotic signatures from a plurality of identified reference images to extract a ranked, limited set of plausible identifiers to be tested for authentication.

According to an embodiment, the information to in case of unsuccessful authentication a score is delivered based on the consistency of the chaotic signature versus other document chaotic signature to establish how close the candidate document is to a family of document and how precise is this classification.

As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 describes show an image typical image, here a wine label as taken from a smartphone

FIG. 2 illustrates image from FIG. 1 process according to application U.S. Ser. No. 17/647,237 and whereas (1124) designate anchor point and (1125) designate ROI Set (Region Of Interest) forming the chaotic signature;

FIG. 3 illustrates the flow chart to store the information in the Blockchain to store the chaotic signature using the Document name to Generate a AssetID for the Registration phase

FIG. 4 illustrates the flow chart to retrieve the information about the chaotic signature in the Blockchain and check the candidate image versus the signature of the original Image for the Authentication phase

FIG. 5 depicts a registration UI using direct wallet-to-BCSS wherein wallet app 506 on smartphone 501 encrypts object image, generates AssetID from Document Name 507+WalletID+timestamp, sends to apparatus 503 (with decryption key), storing AssetID/BlockchainID for authentication.

FIG. 6 depicts a registration UI using indirect wallet-to-BCSS/apparatus connection,

FIG. 7 shows authentication UI: a new image of original document 502 is captured digitally, AssetID entered manually or via OCR, the image and AssetID sent to apparatus, which retrieves BlockchainID from database, fetches chaotic signature/WalletID via BCSS 705, performs authentication, and returns status (e.g., authenticity signal, WalletID/owner details, or integrated notifications).

FIG. 8 is the display of one ROI organized as a multi-scale tile matching (256→256, to 64→64). The reference image, here for exemplification a banknote, this ROI is successfully and even ideally matching the candidate image (candidate image is a different image capture of the same banknote). For sake of clarity not all ROI (1125) are labeled

FIG. 9 is the display of the same reference image ROI set as FIG. 8, but here as expected failed to match on the candidate image at proper position (here the candidate image is from an extremely similar capture but of another banknote than the reference). The dispersion of positions of matchs can be appreciated. For sake of clarity also not all ROI 1125 are labeled.

FIG. 10 exemplify a document object as digital geometric object, here a page as could be a PDF or a DOCX or a part of a 3D design

FIG. 11 is document (108) of FIG. 10 (100), with addition of Digital Marker (104) and (106)

FIG. 12 exemplify an embodiment of Digital marker of FIG. 11 (104) and (106)

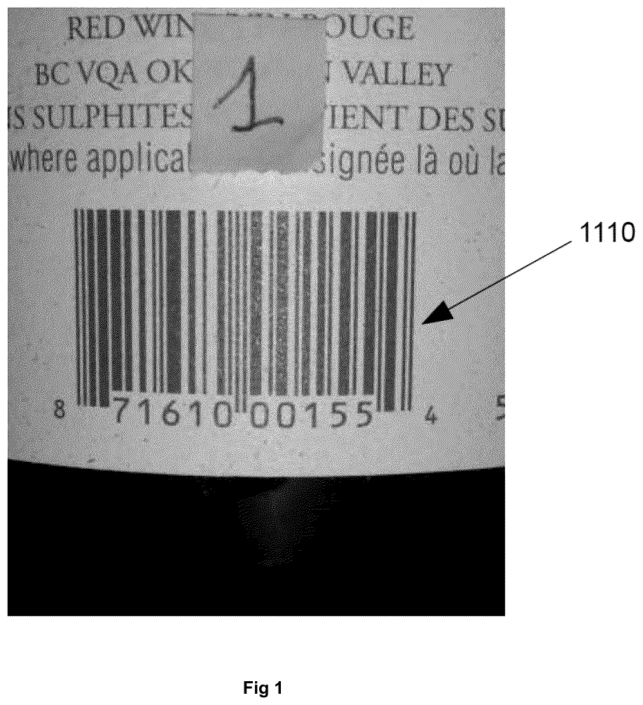

It will be noted that throughout the appended drawings, like features are identified by like reference numerals.

It will be appreciated that the blocks depicted in the diagrams represent functional groupings may have been expanded for sake of clarity however can be practically integrated in another block as the implementation require it. To exemplify this service 504 (server) is illustrated in FIG. 5 as an external component but may be integrated as part of the code executing on device 501.

### DETAILED DESCRIPTION

The apparatus of the present invention addresses the problem of registering and authenticating digital objects (in image or document form) on a public blockchain while avoiding storage of the original, non-obfuscated content. Registration and authentication are performed using an “obfuscated representation” and a comparison methodology analogous to that employed by visual experts rather than strict byte-for-byte matching. The original image may therefore remain confidential or be discarded after registration; authentication of candidate objects relies solely on the stored chaotic signature serving as a proxy.

Embodiments describe systems and methods for working with documents stored in publicly readable databases, such as blockchains, by storing data that enable high-precision authentication at a level comparable to blockchain-grade hashing (e.g., on the order of 256 bits of security), while accommodating documents or images that are not digitally identical but whose information entropy supports reliable comparison. This is advantageously achieved by storing an obfuscated dataset that (i) prevents reconstruction of the original document and (ii) still enables unique identification of candidate objects.

The operation may involve two steps; a registration process to store a digital digest (chaotic signatures) as an obfuscated data set and an authentication process where a candidate document or image is submitted to the process and a query is made to retrieve the associated registration digest of obfuscated data for the stored reference documents, allowing to further conduct a precise authentication to be done between the obfuscated data acting as a proxy of the document, and directly the candidate document or image.

### Terminology and Nomenclature and Details

The subject matter disclosed herein involves multiple parties, data types, and system components. For clarity of description, the following terms, roles, and conventions are defined for use throughout this specification and are added some details about the specific description of their usage.

### Objects and Documents

As used herein, the term “Object” denotes either: (i) a physical object that is digitized, for example by acquisition of a high-quality image (e.g., JPEG); or (ii) a native digital object that can be rendered as an image or that embeds a digital identifier, such as a watermark or other digital marker.

The term “Document” is used as an extension of the concept of an image, and may comprise: (i) an electronic file converted to an image representation, optionally “salted” with pseudo-random noise for uniqueness or steganographic purposes; or (ii) an image that inherently contains sufficient high-frequency content to support robust feature extraction. In additional embodiments, a document may be a purely digital geometrical description of the object, such as a 2D drawing (e.g., PDF) or a 3D model (e.g., CAD or similar vector-and-texture description).

An “Reference object”, also referred to herein as a “original document” denotes the first registered digital representation of an object, such as the first captured digital image or canonical digital document associated with that object. A “Candidate Object” (or “candidate document”), also referred to herein as a “probe object,” denotes any subsequent digital representation intended to be evaluated against the Reference object for authentication purposes. Non-limiting examples include camera snapshots of artwork, images of wristwatches, paper labels, banknotes, landscapes, minerals, computer-rendered art, or, more generally, any imagery derived from the Reference object.

When the reference object is part of a series of optically similar products—for non-limiting examples, drug blisters, wine labels, banknotes, handbags, watches, or a unique painting within a broader class—its is of interest to establish that some data pertinent to the authentication are of a generic nature and can optimally be shared for the whole class of these objects as the Document Class.

Each Document Class is associated with a class identifier, such as a class UUID or GUID, to facilitate indexing and lookup operations, and may further include a human-readable description for user-interface purposes.

### Uniqueness

In the context of blockchain systems, a value is deemed “Unique” when, within the intended universe of discourse, it is assigned to one and only one object. Although such identifiers are represented in binary form and drawn from a finite space, it is commonly accepted that identifiers of length on the order of 256 bits as in used in the Blockchain industry provide a sufficiently low probability of random collision for practical applications.

### Blockchain and BCSS

As used herein, the term “Blockchain” (abbreviated “BC” where appropriate) refers to a distributed ledger system providing immutability and public or semi-public verifiability, used to anchor ownership and authentication data. A blockchain is a database that permits only queries or insertions but no modification of existing records; accordingly, the terms “database” and “blockchain” may be used interchangeably herein provided that the database enforces append-only operation without record modification.

A “Blockchain Service Supplier” or “BCSS” denotes an entity or system that exposes an application programming interface (API) for writing data to, and/or reading data from, a blockchain. Non-limiting examples include public networks such as Ethereum or Solana, and permissioned or private blockchains such as IBM Hyperledger. In some embodiments, blockchain functionality is implemented and operated by the apparatus manufacturer and may be embedded, in whole or in part, within the apparatus itself, such that the apparatus acts as or includes a BCSS.

Roles: Operator, Owner, Observer

An “Operator” is typically an entity, such as a company or service provider, that deploys, configures, and manages the apparatus. The operator maintains one or more server systems configured to receive, store, and process image or document data and to communicate with at least one BCSS via an API or direct BC access. The operator's servers further expose at least one operator API for bidirectional communication with one or more client-side applications, which may include digital wallet applications, web browsers, and automated software agents.

In some embodiments, the operator role is performed by an end User, for example where application-level access to a blockchain is provided directly via a mobile app or web interface. In one embodiment, the operator operates the apparatus in cooperation with a human end user executing a client application on a smartphone equipped with an integrated camera, thereby enabling capture and submission of images for authentication. Other embodiments may employ tablets, dedicated imaging terminals, automated capture stations, or machine-to-machine interfaces.

An “Owner” is a specialized instance of a user that holds a proprietary, custodial, or otherwise legally cognizable interest in an object and is capable of evidencing such interest, for example via a digital wallet in which a blockchain token or record corresponding to the object is associated with an address controlled by the owner. The owner may be a natural person or a legal entity, acting through a representative or an automated system. Technically, an object always has an owner, at minimum the first user who captures an image thereof using the apparatus; ideally, the first owner is the manufacturing entity. If the genuine owner did not initially use the apparatus, the chain of custody may be enriched later upon discovery of ownership information. For purposes of this description, “Owner” refers to the user associated with the current registered WalletID (described elsewhere) that performed the reference-image registration.

An “Observer” is an instance of a User that submits a representation of an object or document, such as a digital image thereof, for authentication in order to determine whether the object is validly associated with an owner as recorded on a blockchain or another registry. The Observer may be the Owner, or in general a natural person, a legal entity, or an automated system, and may interact via an operator-supplied client application and/or an interface, wallet, or software component supplied in coordination with a BCSS.

In some embodiments, the Observer is a subject-matter specialist, otherwise said an Expert (e.g., jeweler, art appraiser, counterfeit-note examiner or original manufacturer or AI based expert); in others, the Observer is any user or agent capable of acquiring a digital image and, preferably, providing at least one unique identifier (e.g., serial number). Where the observation is the first known instance of the object, the Observer may assign an arbitrary unique number or infer an expected serial number based on expertise.

A “Reputable authority” is an individual, organization, or computer-based voting system acting as an operator or expert, mutually agreed upon by the relevant parties as competent, independent, and capable of acting in confidence. The reputable authority provides a final opinion or adjustment regarding the genuineness of registered data representing the document, with a given access to all the original information available, without disclosing theses underlying information.

### Identifiers

In a preferred embodiment, the apparatus employs at least two primary identifiers: (i) a wallet identifier (WalletID) unique to the owner; and (ii) a document identifier (AssetID) for the object or document.

Various strategies may be employed to generate or enrich an AssetID until it is deemed sufficiently unique within the relevant namespace.

The initial AssetID persists through ownership transfers and remains unique throughout the lifecycle of the document. Blockchain-internal identifiers (collectively “BlockchainID”), derived from the AssetID, payload, or WalletID, enable retrieval of the latest record in the database. In other words, the AssetID endures as a fixed reference across the document's lifetime, whereas the BlockchainID is updated with each new insertion; notably, the first ever registration of the AssetID generates an initial BlockchainID that, by the nature of blockchain immutability, remains a permanent string identifier for the object at least as robust as the AssetID. DocumentID is a synonym of AssetID.

The uniqueness guarantee for all identifiers conforms to accepted blockchain-industry standards, namely the collision resistance of the underlying blockchain hashing algorithms, and a bijection is assumed between AssetID and the corresponding blockchain record or payload.

The term “Official Identifier” denotes, at any given stage of processing, the identifier best suited to uniquely reference the object with respect to the ultimate BlockchainID. Prior to on-chain commitment, multiple identifiers may exist and later be persisted to the blockchain. By way of non-limiting example, a first usable Official Identifier may be a raw hash of digital data; followed by the AssetID once recognized from the object or established by the user and uniqueness is guaranteed; then a master hash of the digital signature (described elsewhere); then an IPFS hash; and finally the latest BlockchainID once written to the blockchain (noting that append-only databases like blockchains permit backward traversal to the first BlockchainID from initial registration).

As used herein, a “obfuscated data” or “Chaotic Signature” is a compact digital digest derived from an image of a document or object, consisting of numerical values that capture sufficient entropy of the document to uniquely characterize it for later authentication, even when subsequent images differ at the binary level (for example, due to recompression or recapture). The terms “obfuscated data”, “Optical signature” and “Chaotic Signature” may be used synonymously, with “Chaotic Signature” preferred where greater conceptual clarity is desired.

In one embodiment, the chaotic signature is generated using classification techniques from the Computer Vision field based on Markov Random Fields, such as those described in U.S. Ser. No. 17/647,237, which yield a reduced set of tiles or feature indices that remain stable across perceptually similar but digitally distinct images. In another embodiment, the chaotic signature is generated using processes of the type disclosed in U.S. Ser. No. 12/114,685, or any equivalent feature-selection method that produces a reproducible and discriminative digest suitable for robust image matching.

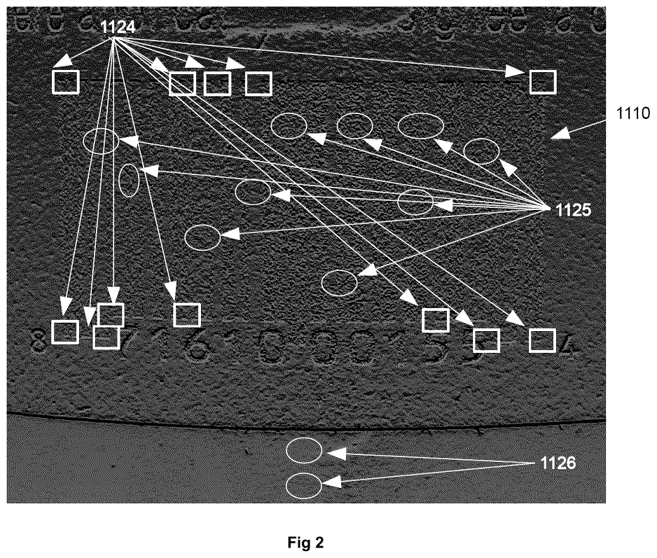

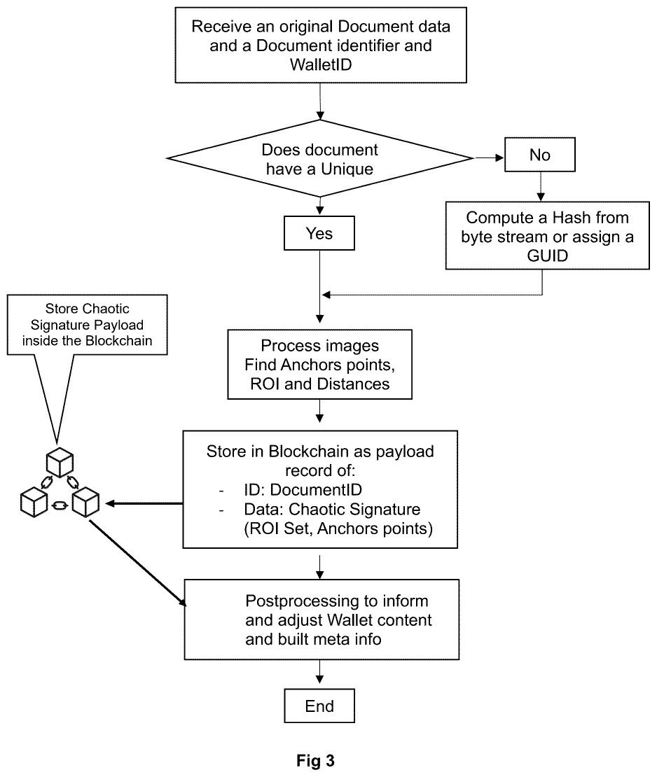

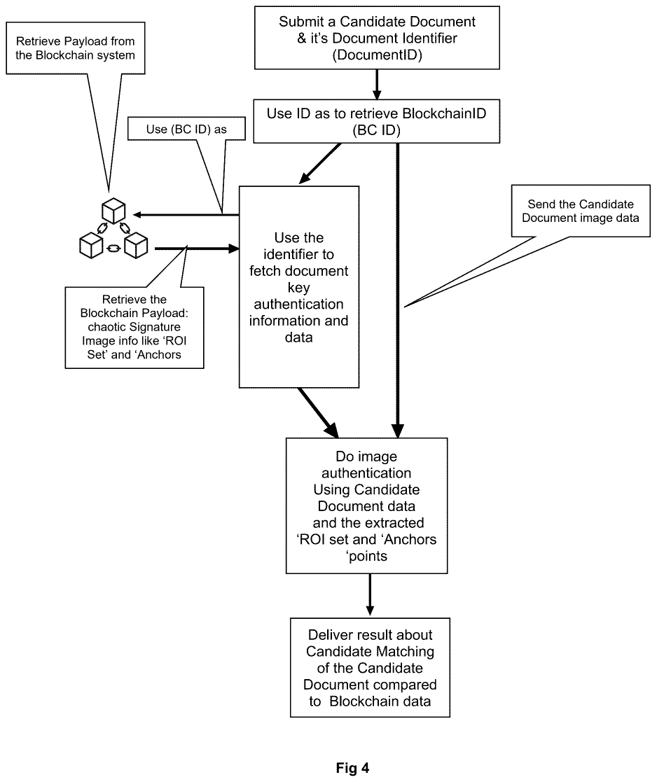

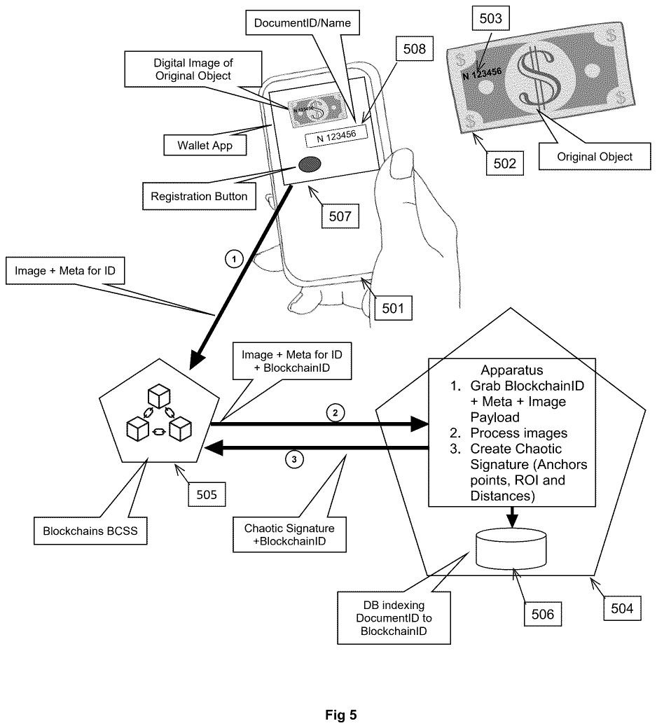

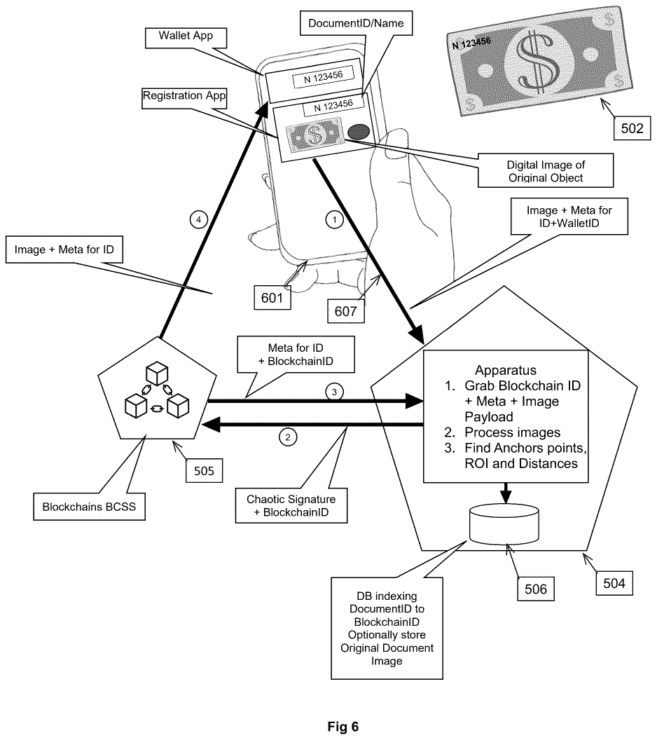

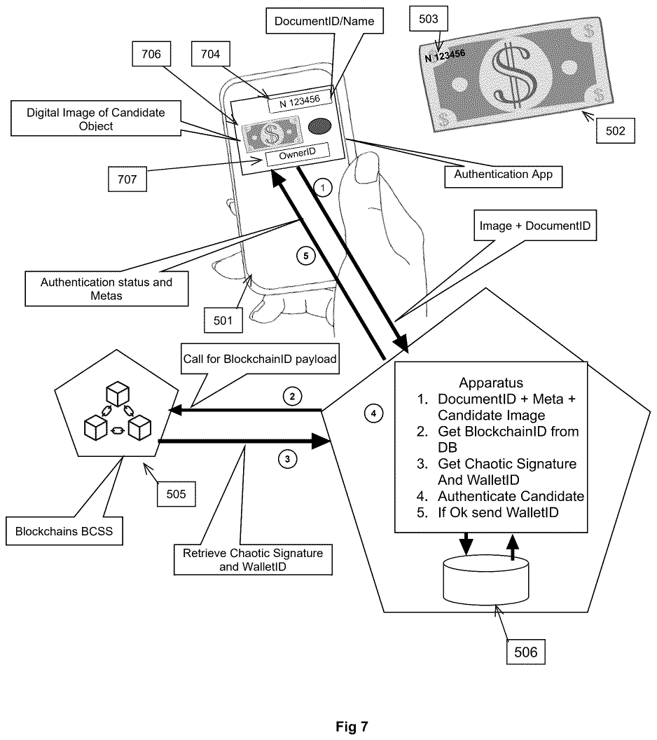

In representative implementations of the “Chaotic Signature”, at least two categories of information are employed: (i) data patterns and (ii) rules for using these patterns. In a preferred embodiment, three classes of information are combined: (a) “anchor points” (FIG. 2 1124), (b) “regions of interest” “(ROIs)” (FIG. 2 1125), and (c) “distance or relational values” between anchor points and ROIs. The aggregation of these three information types forms a chaotic signature that uniquely characterizes the image for authentication purposes.

In alternative embodiments, the chaotic signature may comprise parameter values of a trained machine-learning model, such as the weights of a neural network configured to recognize and authenticate a specific document or document class. Such parameter sets may be structured hierarchically, where coarse-level parameters encode class-level commonalities (document-class identification) and fine-level parameters encode instance-specific features (document-level authentication).

In all embodiments, any digital digest that enables robust authentication of a Reference object across variations in format, resolution, compression, or capture conditions is referred to herein as a “Chaotic Signature”. Where the digest is based primarily on regions of interest, the term “ROI set” (set of Regions Of Interest) may be used interchangeably with chaotic signature for convenience. “Digital Marker”: In additional embodiments involving native digital documents that are not exclusively images, the apparatus supports authentication of vector-compatible formats (e.g., word-processing files, PDF files, 3D vector representations) by means of a “Digital Marker” if embedded in the document, for example of the type described as embedded message in U.S. Ser. No. 14/344,667. The Digital Marker, being a universally unique identifier or signature, enables verification of document assignment and ownership using the same apparatus. In such cases, image capture and ROI-set processing are replaced by programmatic extraction: the apparatus parses the document format to locate and validate one or more embedded digital markers.

The Digital Marker provides persistent traceability through ordinary document modifications or format conversions, maintaining a recognizable, unique component that identifies the document. Absence of a valid Digital Marker may be treated as prima facie evidence of falsification. Copies of the digital document do not confer ownership; all instances remain attributable to the registered owner as indicated by the marker and associated records.

The Digital Marker may be: (i) intrinsically unique as generated, or (ii) rendered unique by modification or augmentation with an additional information like a hash or a UUID, thereby serving as an authentication signature. In some embodiments, the Digital Marker is used alone; in others, it is the primary signature and maybe is supplemented by rendering the document as an image and performing an authentication process as describe for image case, thereby confirming visual fidelity and improving resistance to tampering.

Where a Digital Marker is present but no ROI set has been generated from an image or texture representation, the Digital Marker is treated, for purposes of this description, as a functional equivalent of a Chaotic Signature.

### Processes: Registration and Authentication

“Registration” denotes a process by which ownership of a document or object by an owner is digitally attested, in a manner analogous to notarization. In one embodiment, the owner: (i) selects or generates a preferred digital representation of the object; (ii) associates that representation with a digital wallet controlled by the owner; and (iii) assigns a document name that is unique within the context of that wallet. The apparatus then derives and stores authentication data for the Reference object as part of a blockchain payload that references a wallet identifier (WalletID) of the owner.

“Authentication” denotes a process invoked by a User, such as an Observer or the Owner, to verify that a candidate object, purported to correspond to an Reference object or document, is in fact the registered original and is duly associated with the owner. In one embodiment, the user acquires a new image of the candidate object and submits this image to the apparatus, which processes the submission and returns a diagnostic output indicating, for example, whether the candidate matches the registered original and whether the ownership information recorded on the blockchain confirms the association.

“Salting and Controlled Uniqueness.” In one embodiment, the apparatus supports “salting” of low-spectrum, high-frequency content, either with random noise or with steganographic elements (for example, in a manner analogous to systems such as Google SynthID), to introduce controlled uniqueness into otherwise similar images. By design, these salting procedures alter the binary representation of the document and thereby degrade its suitability for producing a stable conventional hash, yet can either be hidden enough so that the authentication phase skip it or alternatively can be tuned to increase the document's effective entropy to a level that allows the system to render an authenticity opinion comparable to a 256-bit collision-resistant scheme.

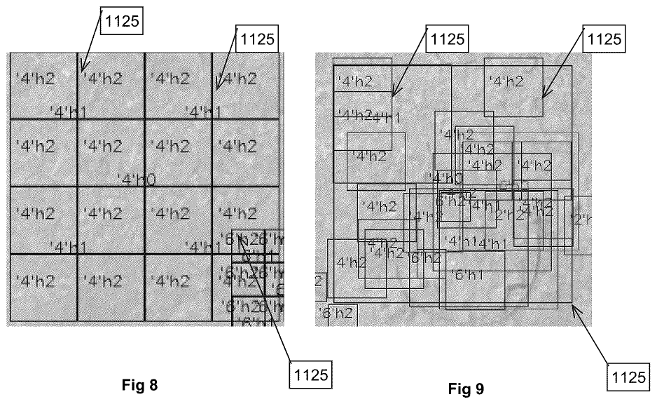

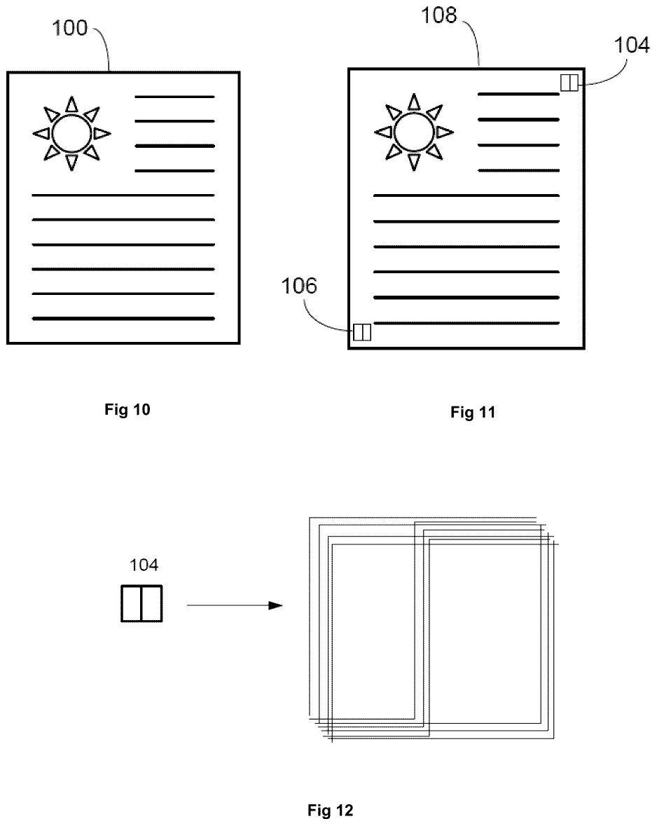

This permits generation of distinct variants of an original artwork or digital asset while preserving compatibility with the authentication process, because the Optical Signature and its chaotic-signature framework remain robust under such controlled variations; small changes that are imperceptible to humans can still be detected and evaluated by the authentication pipeline. In practice, these subtle perturbations may cause corresponding shifts in the Chaotic Signature, and the apparatus can surface candidate matches for final user determination as to whether an examined instance should be treated as a genuine rendition of the original or as a distinct derivative copy. FIGS. 8 and 9 illustrate how these slight image variations are nonetheless captured by the process, demonstrating that “salting” can alter the Chaotic Signature without materially affecting human perception of visual similarity.

“Encryption” while can be done additionally to the already naturally obfuscated payload content, the payload can be encrypted, in an enhanced embodiment the encryption may use Homomorphic encryption avoiding the need to access a decryption key while performing the authentication.

Use of Homomorphic Encryption, unlike conventional symmetric or asymmetric encryption generally necessitates full decryption during authentication, additional embodiments encrypt for example as the “positional (geometric) component” of the chaotic signature using fully homomorphic encryption (FHE) or “partial homomorphic encryption (PHE)”. PHE schemes such as Paillier-type additive cryptosystems allow limited arithmetic (e.g., addition and certain multiplicative forms) on ciphertexts, thereby enabling privacy-preserving similarity computations over encrypted feature vectors.

Applied to the main embodiment, PHE still allows and efficient implementation when restricted to a limited set of critical geometric information in the Optical Signature payload that could remain concealed, while still supporting comparison against newly computed signatures, thereby enabling consistency checks between expected and observed geometries without exposing the expected geometrical structures themselves. PHE thus permits “distance-set comparisons” via homomorphic operations without decryption, for example: distances between ROIs and anchor points and or anchor points coordinates.

### Processing at the App Phase One

Phase one: “Registration” constitutes an initial step by which an object is onboarded into the apparatus. The owner provides the operator with a Reference object, together with either an AssetID or sufficient information from which an AssetID may be derived. A first check is performed to determine whether the reference object already possesses an intrinsically unique AssetID (for example, a banknote serial number or a manufacturer-assigned serial number, such as a vehicle identification number (VIN) or drugs container with its lot or serial number, may be caught through an OCR or Data matrix of alike system), in which case uniqueness is delegated to and enforced by the issuing authority. If such an identifier is inadvertently duplicated, a disambiguating string—such as a high-resolution timestamp, a UUID, or a similar suffix—may be appended to restore uniqueness. Alternatively, the user may generate a proposed AssetID that is checked against existing records, with a different one queried or generated if a conflict is found. Ultimately, the AssetID may be generated by hashing the Reference document data stream (for example, using SHA-256 or a blockchain-native hashing algorithm) to obtain a sufficiently unique identifier, which then serves as the definitive AssetID. If a Digital Marker is found it can be used as an AssetID or a seed for the final AssetID

The apparatus verifies that the AssetID is not already present on the blockchain by attempting to retrieve an associated payload. Lookup may be accelerated by a local mapping between AssetID and BlockchainID, assumed bijective. During verification, a smart contract may pre-reserve the AssetID to prevent race conditions in which another party concurrently attempts registration of the same ID. The Reference object is then processed to extract its chaotic signature, which is stored in the blockchain payload associated with the AssetID.

During registration, it is beneficial to verify whether the reference object belongs to a known class of objects or represents a novel, unique specimen. When the reference object belongs to a series of optically similar products—for non-limiting examples, drug blisters, wine labels, banknotes, handbags, watches, or a unique painting within a broader class—it is not always necessary to generate a new set of anchor points for referencing the position of the region of interest (ROI) for each individual reference document; in fact, it may be advantageous to propose and utilize an optimized, normalized set of anchor points.

In such cases, the present invention provides for establishing a main set of generic anchor points (e.g., as depicted in FIG. 2, element 1124), which may be derived using salient-point methods such as SURF, ORB, LoFT, or similar techniques available in OpenCV libraries, or external visual-recognition services such as those provided by Vuforia. Notably, salient-point methods are inherently obfuscated, as they do not permit reconstruction of the reference object or generation of a realistic outline thereof, such that public storage of feature descriptors does not reveal the underlying content.

This main generic anchor points allows to defines a coordinate system for verifying the proper positioning of individual ROIs across multiple reference objects within the series, in a manner equivalent to that of a specific set of anchor points.

This approach avoids the need to store a dedicated set of anchor points for each reference object, requiring instead only the relative positions of each reference object's ROI with respect to the main generic anchor point set.

For image-based documents, an image-identification step determines the document class, for example using Vuforia or OpenCV SURF/ORB methods:
if identification fails, a new class UUID (Class GUID) is assigned, optionally storing the document name as a human-readable class label;
if identification succeeds, the existing Class GUID is associated with the Reference object.

For non-image documents, for use with de Digital Marker case metadata (e.g., type, author, dates) and or image summary and machine classification are used to create or retrieve an equivalent class identifier.

At least one chaotic signature set is extracted from the Reference object (e.g., ROI set, anchor points, distances). A hash of each chaotic signature dataset is computed to form the “obfuscated data” and a composite “master hash” is derived for the complete obfuscated data dataset (for example, as a hash of the individual chaotic signature data hashes). This master hash ensures integrity of the optical signature data during subsequent operations, providing proof against tampering in a manner conventional to hash-based verification.

A payload is constructed containing at least:
a) the Class GUID or a textual representation thereof;
b) metadata about the object; including the AssetID;
c) one or more optical signature dataset, or the hash of optical signature dataset if stored in separate record or hash sensitive storage system;

In some implementations, for payloads size exceeding accepted tradeoff for storing the data in the blockchain, the blockchain may utilize off-chain storage for the larger portion of the data within a certifiable system that forms part of the blockchain ecosystem, such as non limitatively the InterPlanetary File System (IPFS), a decentralized peer-to-peer protocol for file storage and sharing. In such implementations, the IPFS service returns a hash value that is generated from the entirety of the stored payload and is sufficiently unique to serve as a substitute for a master hash in subsequent operations. In conventional workflows, the payload is first submitted to the IPFS service to obtain this hash, which is then combined with minimal metadata (for example, an AssetID, classification information, and optionally a preview link) for storage on the blockchain itself, thereby minimizing the on-chain data footprint. Although this pre-hashing step can simplify data management, it is not strictly required, since the blockchain-commitment process itself yields a BlockchainID that is at least as unique as any externally supplied hash, and thus can uniquely identify the corresponding asset. Unlike on-chain storage, external storage systems such as IPFS allow deletion of the underlying payload; in such cases, the unavailability of the payload corresponding to the hash recorded on the blockchain should be interpreted as an inability to locate a valid blockchain record that satisfies a consistency check, and thus as a failure to locate a proper blockchain record. For purposes of clarity, the use of external hashed data storage should be regarded as an implementation detail that does not alter the fundamental operation of the blockchain-based commitment scheme.

The payload is finally written to the blockchain, yielding a BlockchainID that facilitates subsequent lookups using the AssetID and/or Class GUID as indices.

Optionally, the Reference object may be represented by multiple captures (e.g., different sides or under slight variations in pose or illumination) to refine anchor points and ROIs, thereby enhancing authentication robustness. Multiple payloads may thus be created on the blockchain, each linked by the same AssetID seed is referred to herein as a “View.” This enables a rule-based set of views to be used during authentication under AND logic (all views must authenticate successfully), OR logic (at least one view suffices), or derivatives such as pyramidal hierarchies (e.g., authenticating a box, then its contents) to strengthen the authentication process or ease identification. Non-limiting examples include authenticating a pill as belonging to an authenticated blister pack, which is itself part of an authenticated pharmaceutical box. The set of Views can be packed as a unique payload of payloads, or set as individual payload under individual AssetID as combination of a first AssetID and individual View names.

### Processing at the App Phase Two

Phase two: Authentication (Retrieval and Comparison): In an authentication phase, a computing system receives a candidate image or sub-image together with a minimal set of identifying information. Preferably, this information comprises a BlockchainID; alternatively, it may comprise an AssetID, an object name to be resolved via a search facility, or even the Reference object itself from which the original hash can be recomputed, with the goal of ultimately identifying the BlockchainID corresponding to the reference object.

Using the latest available Official Identifier, the system progressively queries the blockchain or an associated database to retrieve the chaotic signature set corresponding to the reference object, including—for image documents—regions of interest (ROIs), anchor points, and associated distances, or—for digital documents—digital markers as described elsewhere herein. If present, the Class GUID is also retrieved; if not present, an image recognition phase of the same nature as that described in the registration phase above may be performed to establish the reference Class and thereby assist in retrieval of the reference object's obfuscated data or to complement it.

The system then applies an authentication algorithm, for example of the type described in U.S. Ser. No. 17/647,237, comparing the candidate image to the stored chaotic signature and producing an opinion regarding authenticity, returned to the observer as a probability value or as a binary decision using thresholds during the probability computation.

The authentication system does not require access to the Reference object; it operates exclusively on the chaotic signature retrieved from the blockchain or associated storage, without needing the original content.

### Extension of Chaotic Signatures

In some instances, a single chaotic signature derived from one region of interest (ROI) may be insufficient to produce a decisive authentication result, for example when images of a given object exhibit greater variation than initially anticipated. As described in systems of the type of U.S. Ser. No. 17/647,237, multiple ROIs may be evaluated and their scores aggregated to obtain a reliable decision, taking into account alternative ROI and anchor-point configurations.

In such embodiments, the apparatus can detect that additional evidence is required (e.g., repeated borderline scores) and initiate re-evaluation or extension of the chaotic signatures stored on the blockchain. This may include generating additional chaotic-signature sets and/or re-weighting ROIs that consistently yield strong matches. A new blockchain record may then be created for the same Reference object, with an updated payload containing an enriched chaotic-signature set. During authentication, the system may first test an initial chaotic signature and, if unsuccessful, iteratively test additional stored signatures until a decision is reached, subject to predefined limits (for example, combining no more than a specified number of ROI-based scores) to reduce overfitting and bias.

A practical benefit is that observers, who may operate under superior capture conditions or with higher-quality hardware than the original owner, can supply higher-quality candidate images that, once positively authenticated, justify updating or extending the registration data. Under controlled policies, a positive authentication event may therefore be used to register a new image-derived chaotic signature set linked to the same Reference object, while imposing constraints that prevent systematic drift or exploitation for counterfeit generation.

This approach is especially advantageous for objects that naturally wear over time (for example, shoes, bags, or other frequently used items). The owner may register additional, more recent images before wear renders the object too visually distant from its initial appearance to match the original chaotic signature, thereby preserving the ability to authenticate the object across its lifecycle.

Furthermore, the method permits a broad user base to indirectly contribute to enrichment of the registration set without exposing original imagery. A reputable authority (for example, a law-enforcement agency, certified expert, attorney office, certification bureau) may hold high-resolution reference images—such as images acquired with optics providing several times the pixel density of typical consumer devices—and use these to derive enhanced chaotic signatures. These enhanced, non-visual signatures can then be supplied back to the system to widen the acceptable variation range for positive authentication of candidate images, while the high-resolution reference images themselves remain confidential.

### Matching Process to Deduce AssetId

In an improved embodiment, an AssetID is inferred directly from a candidate image, without requiring the observer to provide an identifier.

For this purpose involving a multiplicity of original registered Document each registered document is associated with a chaotic signature comprising a set of ROIs. Duplicate ROIs across documents may be filtered, and each distinct ROI indexed with the one or more AssetIDs to which it belongs. During authentication, ROI matching is performed against the aggregated ROI index, yielding matches for multiple AssetIDs; ROIs from the correct reference document statistically dominate, and grouping by AssetID produces a ranked list of candidate AssetIDs.

In this improved embodiment, Optical Signature pattern data (e.g., 256×256-pixel tiles, as in FIG. 2 element 1125) are subjected to dimensionality reduction and stored in an artificial neural network (ANN) or approximate-nearest-neighbor engine (e.g., FAISS-type). An Optical Signature extracted from the candidate is first compared in this reduced space, yielding a small set of high-scoring AssetIDs with similar ROIs; this may trigger a subsequent full-resolution chaotic-signature authentication on the reduced set of AssetIDs.

Multiple chaotic signatures stored for a given original document reinforce the same AssetID in the ranking, improving robustness. Preliminary recognition (e.g., SURF/ORB matching, OCR, or AI classification) may also infer a document class and Class GUID, restricting ROI searches to that class and thereby reducing computation while improving discrimination.

If the AssetID ranking is not decisive, a subset of top-ranked AssetIDs satisfying a minimal match condition is selected, and an enumerative authentication phase using additional discriminants (e.g., distances to anchor points) is applied. If no clear result emerges, the apparatus may request an alleged AssetID from the observer.

When no exact reference is authenticated, the system may return a qualitative similarity indication, based on the frequency and strength of matches to classes and references, thereby approximating a non-parametric classification. Proximity to known references (e.g., via Parzen-window—type criteria) may be reported as a score of similarity to the family of stored reference objects for this class and the associated error range, without asserting identity.

### Hash-Equivalent Collision Properties

The principle of cryptographic hashing (for example, SHA-256) is typically analyzed in terms of the number of effective bits in the result and the corresponding collision probability. In at least one embodiment, the chaotic-signature—based authentication process is configured so that the probability of incorrectly accepting a counterfeit object as the original is no greater than the collision probability of a conventional blockchain hash (e.g., 256-bit).)

As in part of the Makov Random Field MRF Bayesian art in computer vision for texture scoring, one may equivalently reason in probabilistic terms rather than strict bit counting; the essential requirement is that the probability of a false positive (collision) in the ROI-based scheme be no higher than that of the underlying cryptographic hash used in blockchain systems. In practice, some geometric redundancy exists because multiple links to the same set of anchor points are not fully independent; however, the implementation can increase the number of ROIs, or adjust their size, to achieve the desired effective bit strength

In one illustrative embodiment, at least 16 regions of interest (ROIs) sized 256×256 pixels, each containing 16 sub-tiles of 64×64 pixels, are evaluated using a similarity metric such as normalized pattern matching (e.g., OpenCV CCORR-NORMED), which produces a value R(x, y) between 0 and 1 for the match at position (x, y).

As described in the related art, the value R(x, y) is not used directly as an authenticity score but to localize a plausible position of the template within the candidate image (otherwise said measuring the distance of ROI to anchor points).

As Illustrated in FIG. 8 as success to match Reference document ROIs at right place and FIG. 9 as failure to match original document ROIs at right place. The right places are the registered position of the original document ROIs to be considered as distance to anchor points that are not visible on these figures. This converts the matching into an event detection process, wherein the apparatus seeks a sufficiently similar ROI—characterized by a combination of scores from its 64×64 sub-tiles—at the expected location, with positional drift not exceeding one-quarter of the tile size (e.g., the top 10% of candidates). The distance from the tile center to at least two anchor points is then verified to confirm the ROI's position in 2D space (thus requiring at least two anchor points). Using probabilistic mathematics these individual draws are combined (product) to create a combined rate of successful draw which is rated versus the number of draws and converted in bits, deemed sufficient to deliver a score as a rating over 256 bits or more, warranting a successful authentication outcome.

To exemplify the concept and quantify the probability of matching using this probabilistic approach, modern smartphones capture 24-megapixel images, an object typically occupies at least 40% of the frame (below which the system deems coverage insufficient), yielding approximately 10 megapixels of usable object data approximated as square for exemplification as a 3162×3162-pixel grid, the number of distinct 64×64-tile positions is close to 9,603,801, and the number of ways to choose 16 distinct tiles among them is given by the binomial coefficient C(N, 16) with N≈9.6×10\hat{ }6, yielding on the order of 10\hat{ }98 possible combinations. In other words, there are roughly 10\hat{ }98 different possible landing zones for the ROI of 64×64.

The apparatus can thus be configured so that its effective collision probability matches or improves upon NFT-style hash collision probabilities, while still allowing a tunable trade-off between robustness to low-quality candidate images (for example, smartphone captures) and strictness for high-quality near-original images. For small or low-resolution candidate images that carry fewer usable ROIs, the system may still output a similarity probability with fewer effective bits; in many real-world scenarios, such a similarity level on small images is deemed sufficient to establish ownership, since minor appearance variations do not alter the practical conclusion that the candidate is a duplicate of the original.

### REFERENCES

1. How to Identify an NFT from an Image NFT OSINT part 3

https://osint2h22v.substack.com/p/how-to-identify-an-nft-from-an-image
2. Blockchain-based image processing method and apparatus Zhiguo Li

https://patents.google.com/patent/us10922422b2/en
3. Systems and methods for blockchain-based non-fungible token (nft) authentication

Luke JURAT, Vuk RADOICIC, Stefan LAZOVIC, Brandon CASTRO, Jeffrey G. POLI

https://patents.google.com/patent/U.S. Pat. No. 10,922,422B2/en

https://patents.google.com/patent/U.S. Pat. No. 12,204,671B2/en
4. Secure image retrieval method based on homomorphic encryption

https://patents.google.com/patent/CN103744976A/en
5. Secure matching and identification of patterns

Sharathchandra Pankanti, Karthik Nandakumar, Nalini Ratha, Shai Halevi

https://patents.google.com/patent/U.S. Pat. No. 11,321,382B2/en
6. Systems and method for tracking enterprise events using hybrid public-private blockchain ledgers

Jenny Lin, Perry Haldenby, John Jong Suk LEE, Paul Mon-Wah CHAN, Orin Del Vecchio

https://patents.google.com/patent/US20170046651A1/en
7. Integrity Authentication Based on Blockchain and Perceptual Hash for Remote-Sensing Imagery

Xu, Dingjie search by orcid; Ren, Na; Zhu, Changqing

https://ui.adsabs.harvard.edu/abs/2023RemS . . . 15.4860X/abstract
8. Markov Random Fields and Stochastic Image Models

Charles A. Bouman https://engineering.purdue.edu/~bouman/ece641/mrf_tutorial/view. pdf
9. Encrypted Vector Similarity Computations Using Partially Homomorphic Encryption: Applications and Performance Analysis

Sefik Serengil, Alper Ozpinar

https://arxiv.org/abs/2503.05850
10.Proof of image authentication on a blockchain

Jeffrey McGregor, Craig Stack, Jason Lyons, Matthew Robben

https://patents.google.com/patent/U.S. Pat. No. 10,361,866B1/en
11.Vision-based operating method and system

Bruno Delean

https://patents.google.com/patent/U.S. Pat. No. 7,945,076B2/en
12.Tracing an electronic document in an electronic publication by modifying the electronic page description of the electronic document Guy Le Henaff

https://patents.google.com/patent/U.S. Pat. No. 8,762,828B2/en
13.Comparative analysis of homomorphic encryption schemes for encrypted image processing in OpenStack using TenSEAL*

Hekmat Sakera, Farid Eyvazova, Tariq Emad Alib, Csaba Biróca, Dhulfiqar Zoltán Alwahabd

https://ami.uni-eszterhazy.hu/uploads/papers/finalpdf/AMI_62_from123to142.pdf CLAIMS:

1. A computer-implemented method for authenticating a candidate document against a reference document using a digest of the reference document stored in a database, the method comprising:
receiving one or more original images of the reference document;
processing the one or more original images to generate one or more sets of obfuscated data and associating a unique identifier therewith;
storing the one or more sets of obfuscated data as a digest of the reference document in the database;
receiving, from a computing device, an authenticity request for the candidate document to be compared against the reference document, the request including at least one candidate image;
searching the database to retrieve the one or more sets of obfuscated data associated with the reference document;
performing an authentication process on the data of the candidate document using the retrieved one or more sets of obfuscated data for the reference document; and
determining the similarity of the candidate document based on results of the authentication process.

2. The method of claim 1 where the obfuscated data are encrypted.

3. The method of claim 2, wherein obfuscated data are composed of two categories of data, one of them being simple values of a nature and quantity compatible with usage of a homomorphic encryption to be used for comparison and theses data being encrypted in a part of a payload of a blockchain allowing the authenticity action to be done using these data without a need for decryption.

4. The method of claim 1 where the database is a blockchain.

5. The method of claim 1, wherein the Reference object or set of documents is stored in its original form at a non-public location accessible to a reputable authority, and wherein the reputable authority processes the original image to verify genuineness of the alleged reference obfuscated data stored in the database.

6. The method of claim 1, wherein successful authentication of the candidate image triggers computation of an additional set of obfuscated data therefrom, to enrich and update the set of obfuscated data for the reference document in the database.

7. A method for authenticating a candidate document against a previously registered reference document stored in a database, the method comprising:
receiving one or more original images of the reference document,
processing the one or more original images to generate one or more set obfuscated data, associating a unique identifier from said set of obfuscated data;
storing in a database the set of obfuscated data and the associated unique identifier,
requesting from a computing device, an authenticity request for a given candidate document, to compare to the Reference object, the request containing at least one candidate,
computing a set of obfuscated data for this candidate,
searching the database using candidate obfuscated data to create a list of reference documents with similar obfuscated data,
performing directly on the candidate document the authentication process from outcome of search of obfuscated data reference documents
determining the authenticity of the given candidate image based on a result of the search and the authentication.

8. A method for allowing comparison of images with a reference stored in a block chain the method comprising:
receiving original images from a Reference object and receiving a unique identifier or a unique description aimed at retrieving the data of the reference image, and additional information to uniquely identify an owner and uniquely naming the document for this owner;
processing at least one of the original images generating at least one chaotic signature in one or more original images associated with said Reference object;
generating a unique document identifier from the additional information to uniquely identify the owner and information from the document;
storing in a blockchain the chaotic signature indexed as a record belonging to the owner for this unique document;
requesting from a remote computing device, an authenticity request for a given candidate image, to compare to the Reference object image;
extracting, by image comparison from a database of all signatures for every document, a set of best-matching signatures;
asserting the unique document identifier that are common to the majority of the best-matching signatures and using it as an alleged unique document identifier;
accessing blockchain record using the image unique identifier;
performing a search for a pre-detected chaotic signature associated with one of the original references, within the received image of the given product, determining authenticity of the given candidate image based on a result of the search,
reporting the result of the authentication process to the authenticity request.

9. The method of claim 1, wherein the unique identifier is deduced from classification of the candidate image chaotic signatures using organized chaotic signatures from a plurality of identified reference images to extract a ranked, limited set of plausible identifiers to be tested for authentication.

10. The method of claim 9, wherein the information to in case of unsuccessful authentication a score is delivered based on the consistency of the chaotic signature versus other document chaotic signature to establish how close the candidate document is to a family of document and how precise is this classification.
